(19) United States
(12) Patent Application Publication
(10) Pub. No.: US 2026/0268036 A1
(43) Pub. Date: Sep. 10, 2026

(54) ELECTRONIC DEVICE INCLUDING DISPLAY DEVICE AND SYSTEM FOR DESIGNING MANUFACTURING FACILITIES THEREFOR

(71) Applicants: Samsung Display Co., Ltd., Yongin-si (KR); Research & Business Foundation SUNGKYUNKWAN UNIVERSITY, Suwon-Si (KR)

(72) Inventors: Ja Gyu HAN, Yongin-si (KR); Sang Do NOH, Suwon-si (KR); Hye Kyung CHOI, Suwon-si (KR); Min Su KWON, Yongin-si (KR); Ho Rim KIM, Yongin-si (KR); Seok Hwan YU, Suwon-si (KR); Hyun Sik YOON, Yongin-si (KR); Dong Hyun LEE, Suwon-si (KR)

(21) Appl. No.: 19/412,272

(22) Filed: Dec. 8, 2025

(30) Foreign Application Priority Data
Mar. 6, 2025 (KR) 10-2025-0028882
May 9, 2025 (KR) 10-2025-0060274

(51) Int. Cl. G06F 30/20; G06F 111/20

(52) U.S. Cl. CPC G06F 30/20; G06F 2111/20

(57) ABSTRACT

A system for designing manufacturing facilities for a display device includes: a manufacturing data server configured to share reference design information for manufacturing lines, standard information for display devices to be manufactured and assembled, and manufacturing process information; an electronic device configured to create a layout drawing and a final design drawing for a plurality of transport equipment and the manufacturing lines according to the reference design information, the standard information for the display devices, and the manufacturing process information based on design requirements and work environment information; and a display device configured to receive the design requirements and the work environment information and to display a simulation process of the electronic device, the layout drawing, and the final design drawing as images.

### CROSS-REFERENCE TO RELATED APPLICATION

The present application claims priority to and the benefit of Korean Patent Application Nos. 10-2025-0028882 and 10-2025-0060274, filed on Mar. 6, 2025, and May 9, 2025, respectively, in the Korean Intellectual Property Office, the entire disclosures of each of which are incorporated herein by reference.

### BACKGROUND

### 1. Field

Aspects of embodiments of the present disclosure relate to an electronic device including a display device and a system for designing manufacturing facilities therefor.

### 2. Description of the Related Art

Display devices and electronic devices using (or including) display devices are becoming more and more important as multimedia technology evolves. In accordance with such trends, organic light-emitting display (OLED) devices, liquid-crystal display (LCD) devices, etc., are currently used as display devices.

Display devices include a display panel, such as an organic light-emitting display panel and a liquid-crystal display panel, as a primary element for displaying images. From among the types of display panels, the light-emitting display panel may include light-emitting diodes (LEDs). Light-emitting diodes may include an organic light-emitting diode using an organic material as a luminescent material, an inorganic light-emitting diode using an inorganic material as a luminescent material, etc.

To assemble and manufacture display panels, display devices including display panels, and electronic devices including display devices, manufacturing products are transported to manufacturing lines by using transport equipment, such as automated guided vehicles (AGV) and linear motion guide devices. For each of the manufacturing lines, for example, washing, deposition, etching, cutting, assembly, and inspection process lines, the corresponding process steps are performed sequentially. Display devices and electronic devices that have completed assembly and inspection processes are then shipped to an external logistics line, etc., by the transport equipment, etc.

To increase the manufacturing yield and manufacturing efficiency of display devices and electronic devices, etc., the manufacturing facilities that include various types of transport equipment and manufacturing lines may be arranged and designed so that each process is performed efficiently.

### SUMMARY

Aspects of the present disclosure provide an electronic device and a system for designing manufacturing facilities therefor that can derive and test the optimal layout and design results for multiple transport equipment and manufacturing lines according to simulation results based on design requirements and work environment information.

Aspects of the present disclosure also provide an electronic device and a system for designing manufacturing facilities therefor that models work environment information on transport equipment and manufacturing lines and modularizes each of the manufacturing lines so that manufacturing logistics connections between each work area and manufacturing line can be freely arranged and changed.

It should be noted that aspects and features of the present disclosure are not limited to the above-mentioned aspects and features; and other aspects and features of the present disclosure will be apparent to those skilled in the art from the following descriptions.

According to an embodiment of the present disclosure, a system for designing manufacturing facilities for a display device includes a manufacturing data server configured to share reference design information for manufacturing lines and standard information for display devices to be manufactured and assembled and manufacturing process information, an electronic device configured to create a layout drawing and a final design drawing for a plurality of transport equipment and the manufacturing lines according to the reference design information and the standard information for the display devices and the manufacturing process information based on design requirements and work environment information, and a display device configured to receive the designer's requirements and the work environment information and displays a simulation process of the electronic device, and the layout drawing, and the final design drawing as images.

According to an embodiment of the present disclosure, an electronic device for creating a layout drawing and a final design drawing for a plurality of transport equipment and manufacturing lines is provided. The electronic device is configured to receive reference design information for the manufacturing lines, standard information for display devices to be manufactured and assembled, and manufacturing process information from a manufacturing data server, receives design requirements and work environment information through a display device, control the layout drawing and the final design drawing according to simulation results to be displayed on the display device, and create the layout drawing and the final design drawing for the transport equipment and the manufacturing lines according to the reference design information, the standard information for the display devices and the manufacturing process information based on the designer's requirements, and the work environment information.

According to an embodiment of the present disclosure, a display device includes a display panel configured to display a design and simulation application processing execution image on a screen, and a display driver circuit configured to control an image display operation of the display panel. The display driver circuit is configured to receive design requirements and work environment information through an input device, such as a touch screen or a keyboard, and to provide them to an electronic device. The display driver circuit is configured to control the image display operation of the display panel so that a simulation process of the electronic device and a layout drawing and a final design drawing are displayed as images on the application execution screen.

According to embodiments of the present disclosure, an electronic device and a system for designing manufacturing facilities therefor can derive highly efficient optimal layouts by utilizing a flexible simulation system based on design requirements and work environment information, and as a result, allow for more efficient design and operation of manufacturing lines.

In addition, according to embodiments of the present disclosure, layout optimization is achieved by an automated process by focusing on the redesign and reuse of simulation models for developing optimal layouts in large-scale plants. Moreover, a flexible simulation system may be used that can cope with various environments by building a multi-layered hybrid model by modeling work environment information for transport equipment and manufacturing lines.

It should be noted that aspects and features of the present disclosure are not limited to those described above and other aspects and features of the present disclosure will be apparent to those skilled in the art from the following descriptions.

### BRIEF DESCRIPTION OF THE DRAWINGS

The above and other aspects and features of the present disclosure will become more apparent by describing, in detail, embodiments thereof with reference to the attached drawings, in which:

FIG. 1 is a perspective view schematically showing a display device and an electronic device and a system for designing manufacturing facilities therefor according to an embodiment of the present disclosure.

FIG. 2 is a plan view showing the display device shown in FIG. 1.

FIG. 3 is a cross-sectional view showing a side of the display device of FIG. 2.

FIG. 4 is a block diagram describing a layout design processing unit of the electronic device shown in FIG. 1.

FIG. 5 illustrates product information and design information input through a design information input unit shown in FIG. 4.

FIG. 6 illustrates information on the space and facility design layout of the manufacturing lines shown in FIG. 4.

FIG. 7 is a flowchart sequentially showing a process of deriving the plant layout and design results by an optimization design control processing unit shown in FIG. 4 and a process of verifying it.

FIG. 8 is a block diagram describing an electronic device including a display device according to an embodiment of the present disclosure.

FIG. 9 is a view showing electronic devices according to a variety of embodiments of the present disclosure.

### DETAILED DESCRIPTION

The present disclosure will now be described more fully hereinafter with reference to the accompanying drawings, in which embodiments of the present disclosure are shown. This disclosure may, however, be embodied in different forms and should not be construed as limited to the embodiments set forth herein. Rather, these embodiments are provided so that this disclosure will be thorough and complete, and will filly convey the scope of the present disclosure to those skilled in the art.

It will also be understood that when a layer is referred to as being “on” another layer or substrate, it can be directly on the other layer or substrate or intervening layers may be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

It will be understood that, although the terms “first,” “second,” etc. may be used herein to describe various elements, these elements should not be limited by these terms. These terms are only used to distinguish one element from another element. For instance, a first element discussed below could be termed a second element without departing from the teachings of the present disclosure. Similarly, the second element could also be termed the first element.

Each of the features of the various embodiments of the present disclosure may be combined or combined with each other, in part or in whole, and technically various interlocking and driving are possible. Each embodiment may be implemented independently of each other or may be implemented together in an association.

Hereinafter, embodiments of the present disclosure will be described with reference to the accompanying drawings.

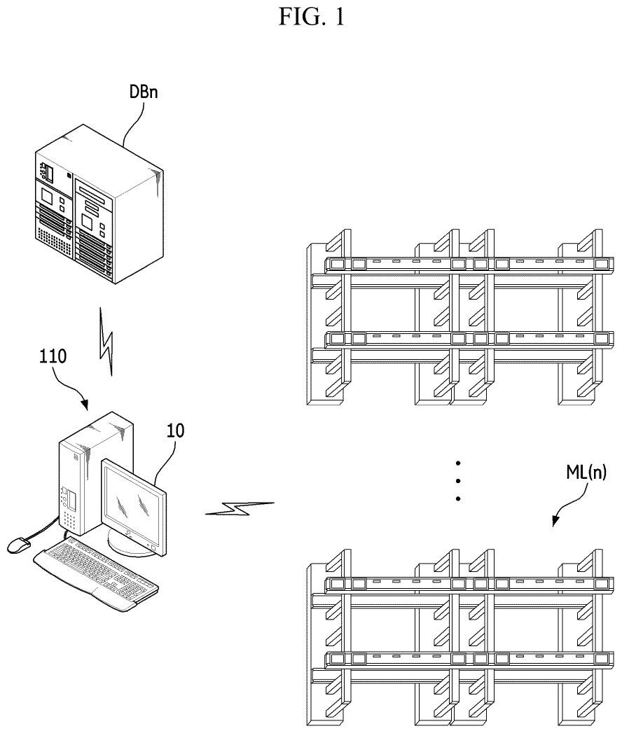

FIG. 1 is a perspective view illustrating a display device and an electronic device and a system for designing manufacturing facilities therefor according to an embodiment of the present disclosure.

Referring to FIG. 1, a system for designing manufacturing facilities according to an embodiment includes: at least a manufacturing data server DBn, an electronic device 110 that generates layout drawings and final design drawings for transport equipment and manufacturing lines ML(n), and a display device 10 for displaying images.

The manufacturing data server DBn stores the reference design information for the manufacturing lines ML(n), standard information on display panels and display devices to be fabricated and assembled, and manufacturing process information and shares such information with the electronic device 110.

For example, the manufacturing data server DBn stores reference design information containing standards for multiple manufacturing lines ML(n), facility specifications for each of the manufacturing lines (ML(n)), and various layout and design formats for the manufacturing lines ML(n) and shares it with the electronic device 110 pursuant to the selection by an operator or a designer.

In addition, the manufacturing data server DBn stores facility-related information containing processing time for each process for manufacturing lines ML(n), process information defining the process flow and process, and component specification information for manufactured and assembled products (e.g., display panels and display devices) and shares it with the electronic device 110. In addition, the manufacturing data server DBn stores manufacturing process information, such as input order information and input location information of each component and material for manufactured and assembled products, and shares it with the electronic device 110.

The electronic device 110 may include a master computer, such as a personal computer (e.g., a general-purpose computer), or a slave computer, such as a tablet PC and a laptop. In addition, the electronic device 110 may include at least a display device 10, such as an organic light-emitting display device.

The electronic device 110 creates a layout drawing and a final design drawing for a number of transport equipment and manufacturing lines ML(n) according to the reference design information, the standard information of display panels and the manufacturing process information, based on designers' requirements (e.g., design requirements) and the work environment information.

The electronic device 110 receives and stores, from the manufacturing data server DBn, reference design information for the manufacturing process lines ML(n), manufacturing process information, and component specification information for manufactured and assembled products, etc., pursuant to the selection by the user or designer.

The electronic device 110 sequentially receives and stores the designers' requirements and the work environment information through input devices, such as a keyboard from the user or designer and a design program (or application program). The designers' requirements and the work environment information may contain (or include): the input and output locations of components for each process section for the manufacturing lines ML(n), area, gap and space layout information for each process section, environmental information, such as ambient temperature and humidity for each process section, manufacturing resource information, such as logistical quantity and layout information for each component, etc.

The electronic device 110 applies the manufacturing process information for the manufacturing lines ML(n), the component specification information for manufactured and assembled products, the designers' requirements and the work environment information to the layout drawing for each of the manufacturing lines ML(n) of the reference design information to create a simulation model. Then, the electronic device 110 applies to the simulation model the clustering shape for each of the manufacturing lines ML(n), the moving path of each product and component, the number of transport equipment for each product and component, the moving path of the transport equipment, and the process period of each process section for each of the manufacturing lines ML(n) as variables, sequentially varies the variables, and performs the simulation sequentially. In doing so, the electronic device 110 performs an optimization simulation to achieve conditions, such as shortening the processing time, reducing the space for each process section, minimizing the number of transport equipment, and minimizing the moving distance. For example, the electronic device 110 may reflect the specifications of the actual transport equipment and track the moving distance to calculate the availability and may optimize the number of transport equipment based on the calculation results, to perform a simulation to design an efficient layout drawing.

The electronic device 110 stores the layout drawing and the final design drawing based on the optimization simulation results as the final results and transmits image data for the final layout drawing and the design drawing to the display device 10.

Each of the manufacturing lines ML(n) may be designed to include a plurality of panel transport modules formed as linear motion guides, and processing equipment or chambers, such as washing, deposition, exposure, etching, coating, packaging, and bonding, etc. Each of the panel transport modules may include: a loading plate on which logistics, such as a carrier and a panel manufacturing substrate are mounted, a coil-type rail for forming the transport axis of the loading plate, a conveyor for transporting the loading plate, and a drive motor for supplying power to the coil-type rail and the conveyor.

Each of the manufacturing lines ML(n) may be laid out or designed to be arranged and connected in a series structure, a parallel structure, or a mesh structure combining series and parallel structures, etc. In addition, at least one transport equipment may be located in (or may be a part of) each of the manufacturing lines ML(n) and between them.

The display device 10 displays an application execution screen, such as design and simulation programs, on the display panel. Then, the display device 10 receives the designers' requirements and the work environment information through a touch screen or keyboard and provides them to the electronic device 110. Finally, the display device 10 may display the simulation process of the electronic device 110 and the layout drawing and final design drawing as images through the application execution screen.

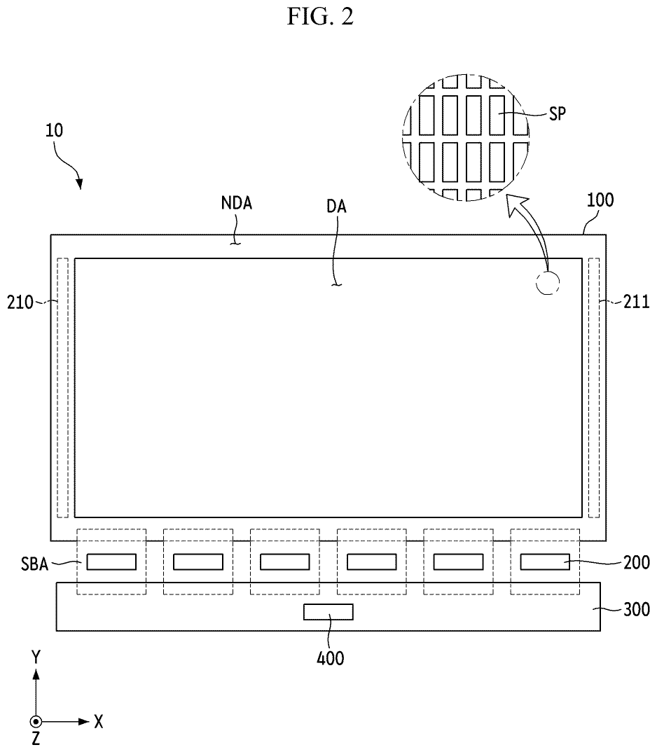

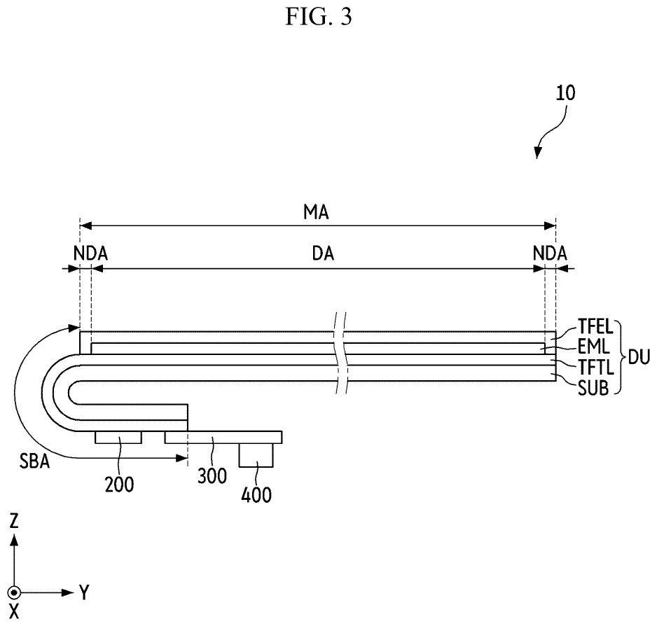

FIG. 2 is a plan view specifically showing the display device shown in FIG. 1. FIG. 3 is a cross-sectional view showing a side of the display device shown in FIG. 2.

Referring to FIGS. 2 and 3, the display device 10 according to an embodiment of the present disclosure may be applied as a large image display, such as a television, a laptop computer, a monitor, an electronic billboard, and the Internet of Things (IOT) device. In addition, the display device 10 according to an embodiment of the present disclosure may be employed by portable electronic devices, such as a tablet PC, a portable multimedia player (PMP), a navigation device, an ultra-mobile PC (UMPC), an electronic notebook, an electronic book, a mobile phone, a smart phone, a mobile communications terminal.

The display device 10 according to embodiments may be variously classified by the way in which images are displayed. For example, the display device 10 may be classified into and implemented as a micro LED display device (micro-LED), a nano LED display device (nano-LED), a liquid-crystal display device (LCD), a plasma display device (PDP), a field emission display device (FED), an electrophoretic display device (EPD), an organic light-emitting diode display device (OLED), an inorganic light-emitting display device (inorganic EL), a quantum-dot light-emitting display device (QED), etc. In the following description, an organic light-emitting diode display device (OLED) will be described as an example of the display device, but the present disclosure is not limited thereto. The organic light-emitting disposed display device OLED will be simply referred to as the display device 10 unless it is necessary to distinguish between them. It is, however, to be understood that embodiments of the present disclosure are not limited to the organic light-emitting diode display device (OLED), and one of the above-listed display devices or any other display device well known in the art may be employed as the display device 10 without departing from the scope of the present disclosure.

According to an embodiment of the present disclosure, the display device 10 may have a rectangular shape, a square shape, a circular shape, an elliptical shape or a quadrangular shape when viewed from the top. For example, when the display device 10 is a large image display, such as a monitor, a television, and a laptop computer, it may have a rectangular shape in which the longer sides are arranged in (or extend in) the horizontal direction. It should be understood, however, that the present disclosure is not limited thereto. When the display device 10 is applied as a mobile device, such as a tablet PC, the longer sides may be arranged in (or extend in) the vertical direction. Alternatively, the display device 10 may be installed rotatably so that the longer sides are positioned in the horizontal or the vertical direction variably.

The display device 10 includes a display panel 100, a scan driver, a data driver circuit 200, and a display driver circuit 400. The scan driver includes first and second scan driver circuits 210 and 211. The first scan driver circuit 210 is a gate scan driver that drives gate lines, and the second scan driver circuit 211 is a sensing scan driver that drives sensing lines. Moreover, the data driver circuit 200 may include a plurality of data drivers formed as integrated circuits. In addition, the display device 10 may further include a touch sensing unit, etc., formed on the front side of the display panel 100.

The display panel 100 of the display device 10 may include a display unit DU for displaying images. The touch sensing unit may be located on the display panel 100 to detect touch by a part of a human body, such as a finger and an electronic pen. The display unit DU of the display panel 100 may include a plurality of pixels SP and may display images through the plurality of pixels SP. The touch sensing unit may be mounted on the front surface of the display panel 100 or formed integrally with the display panel 100.

The display panel 100 may be formed in a rectangular plane having shorter sides in a first direction (e.g., the x-axis direction in FIG. 2) and longer sides in a second direction (e.g., the y-axis direction in FIG. 2) crossing (e.g., interesting) the first direction. Each of the corners at where the shorter sides in the first direction meet the longer sides in the second direction may be rounded with a curvature (e.g., a predetermined curvature) or may be a right angle. The shape of the display panel 100 when viewed from the top is not limited to a quadrangular shape but may be formed in a different polygonal shape, a circular shape, or an elliptical shape. The display panel 100 may be formed flat, but the present disclosure is not limited thereto. For example, the display panel 100 may have curved portions formed at left and right ends and having a constant curvature or a varying curvature. In addition, the display panel 100 may be formed to be flexible so that it can be curved, bent, folded, or rolled.

The display panel 100 has a main area MA and a subsidiary area SBA.

The main area MA includes a display area DA where images are displayed and a non-display area NDA around the display area DA. The display area DA includes pixels for displaying images. The subsidiary area SBA may protrude from (e.g., may extend from) one side of the main area MA in the second direction.

The subsidiary area SBA may be bent, as shown in FIG. 3, and may be located on the lower surface of (e.g., may be arranged under) the display panel 100 when it is bent. When the subsidiary area SBA is bent, it may overlap the main area MA in the third direction (e.g., the z-axis direction in FIG. 3), which is the thickness direction of the substrate SUB. The display driver circuit 400 may be disposed in the subsidiary area SBA.

In addition, as shown in FIG. 3, the display panel 100 includes a display unit DU including the substrate SUB, a thin-film transistor layer TFTL, an emission material layer EML, and an encapsulation layer TFEL, and a touch sensing unit TSU formed on the front surface of the display unit DU.

The thin-film transistor layer TFTL may be located on the substrate SUB. The thin-film transistor layer TFTL may be placed in the main area MA and the subsidiary area SBA. The thin-film transistor layer TFTL includes thin-film transistors.

An emission material layer EML may be located on the thin-film transistor layer TFTL. The emission material layer EML may be located in the display area DA of the main area MA. The emission material layer EML includes light-emitting elements arranged in emission areas.

The encapsulation layer TFEL may be located on the emission material layer EML. The encapsulation layer TFEL may be disposed in the display area DA and the non-display area NDA of the main area MA. The encapsulation layer TFEL includes at least one inorganic layer and at least one organic layer for encapsulating the emission material layer.

The touch sensing unit TSU may be formed on the encapsulation layer TFEL or mounted on the encapsulation layer TFEL. The touch sensing unit TSU may be disposed on the display area DA of the main area MA. The touch sensing unit TSU may sense a touch of a person or an object using sensor electrodes.

A cover window for protecting the display panel 100 from above may be disposed on the touch sensing unit TSU. The cover window may be attached on the touch sensing unit TSU by a transparent adhesive member, such as an optically clear adhesive (OCA) film and an optically clear resin (OCR). The cover window may be an inorganic material, such as glass, or an organic material, such as plastic and polymer material. To prevent deterioration of image visibility due to reflection of external light, a polarizing layer may be further disposed between the touch sensing unit TSU and the cover window.

The first scan driver circuit 210 provides gate scan signals to pixels SP for each horizontal line through gate lines for each horizontal line in the display unit DU based on a first gate control signal from the display driver circuit 400. The first scan driver circuit 210 sequentially provides the gate scan signals to the gate lines for each horizontal line to sequentially drive the pixels SP for each horizontal line.

The second scan driver circuit 211 provides sensing control signals to pixels SP for each horizontal line through sensing lines for each horizontal line in the display unit DU based on a second gate control signal from the display driver circuit 400. The second scan driver circuit 211 sequentially provides the sensing control signals to the sensing lines for each horizontal line and controls a pixel driving voltage for each of the pixels SP to be output to the data driver circuit 200 for each horizontal line.

The data driver circuit 200 may be implemented as a plurality of integrated circuits (IC) and may be attached on the display panel 100 by a chip-on-glass (COG) technique, a chip-on-plastic (COP) technique, or ultrasonic bonding. For example, the data driver circuit 200 may be disposed in the subsidiary area SBA and may overlap the main area MA in the thickness direction when the subsidiary area SBA is bent. In some embodiments, the data driver circuit 200 may be mounted on the circuit board 300.

The data driver circuit 200 may include a plurality of data drivers formed as integrated circuits, for example, a plurality of data driver integrated circuits. The data driver circuit 200 outputs data voltages according to the image data to the pixels SP of the display unit DU based on a data driving control signal from the display driver circuit 400. For example, the data driver integrated circuits may provide data voltages to the data lines DL connected to the pixels SP for each horizontal line every horizontal cycle. In particular, the data driver circuit 200 receives the pixel driving voltage of each of the pixels SP and performs data compensation processing according to the level of the pixel driving voltage, thereby providing the compensation data voltage to each of the pixels SP.

The main area MA of the display panel 100 may include the display area DA where the pixels SP for displaying images are arranged and the non-display area NDA located around (e.g., extending around a periphery of) the display area DA. In the display area DA, light may be emitted from an emission area or an opening area of each pixel SP to display an image. To this end, each of the pixels SP in the display device DA may include a pixel circuit including switching elements, a pixel-defining layer that defines the emission area or the opening area, and a self-light-emitting element.

The non-display area NDA may be an edge or an outer area of the display area DA. The non-display area NDA may be defined as the edge area of the main area MA of the display panel 100. The first and second scan driver circuits 210 and 211 and fan-out lines that connect the data driver circuit 200 and the display driver circuit 400 with the display area DA may be formed in the non-display area NDA.

The first and second scan driver circuits 210 and 211 may be formed separately on one side and the opposite side of the display area DA, respectively. In another embodiment, the first and second scan driver circuits 210 and 211 may be formed adjacent to each other on one side of the display area DA or may be formed adjacent to each other on the opposite side of the display area DA.

The subsidiary area SBA may extend from (e.g., may protrude from) one side of the main area MA. The subsidiary area SUB may be formed as a film made of a flexible material that can be bent, folded, or rolled. For example, when the subsidiary area SBA is bent, the subsidiary area SBA may overlap the main area MA in the thickness direction. The subsidiary area SBA may include pads connected to the data driver circuit 200 and the circuit board 300. In some embodiments, the subsidiary area SBA may be omitted, and the data driver circuit 200 and the pads may be disposed in the non-display area NDA.

The circuit board 300 may be electrically connected to the pads of the display panel 100 by an anisotropic conductive film (ACF). To this end, lead lines of the circuit board 300 may be electrically connected to the pads of the display panel 100. The circuit board 300 may be a flexible printed circuit board (FPCB), a printed circuit board (PCB), or a flexible film, such as a chip-on-film (COF).

The display driver circuit 400 may generate signals and voltages for driving the display panel 100. The display driver circuit 400 may be implemented as an integrated circuit (IC) and may be attached to the display panel 100 by a chip on glass (COG) technique, a chip on plastic (COP) technique, or an ultrasonic bonding. It is, however, to be understood that the present disclosure is not limited thereto. For example, the display driver circuit 400 may be attached on the circuit board 300 by the chip-on-film (COF) technique.

The display driver circuit 400 may operate as a main processor or may be formed integrally with the main processor. Accordingly, the display driver circuit 400 may control the overall functions of the display device 10. For example, the display driver circuit 400 aligns image data input through a processor of the electronic device 110 (e.g., layout design processing unit) and a graphic processor, and provides it to the data driver integrated circuits of the data driver circuit 200 to control the driving timing of the data driver circuit 200. For example, the data driver circuit 200 aligns application execution image data, layout drawing image data, design drawing image data, etc., to match the image display resolution of the display panel and provides them to the data driver circuit 200. Then, the data driver circuit 200 controls the gate scan signal output timing of the first scan driver circuit 210 and the sensing control signal output timing of the second scan driver circuit 211. In addition, the display driver circuit 400 generates data control signals to control the data voltage output timing of the data driver integrated circuits included in the data driver circuit 200.

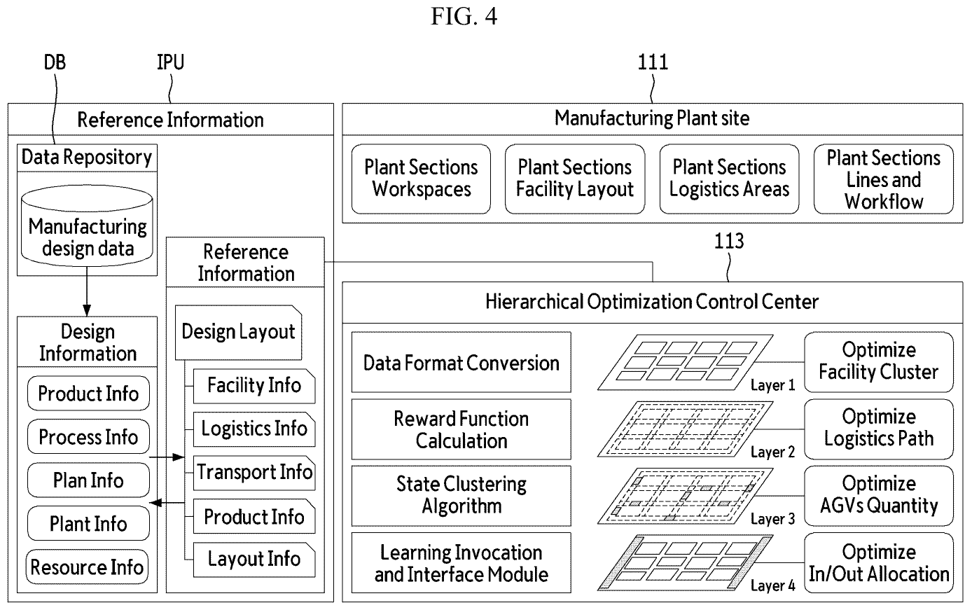

FIG. 4 is a block diagram describing the layout design processing unit of the electronic device shown in FIG. 1.

Referring to FIG. 4, the layout design processing unit included in at least one processor of the electronic device 110 includes an interface processing unit IPU, a manufacturing process setting unit 111, and an optimized drawing designing unit 113.

The interface processing unit IPU receives reference design information for manufacturing lines ML(n) to store it in a database DB and sequentially receives standard information and manufacturing process information for display panels or display devices to be manufactured to stores them in a memory.

For example, the interface processing unit IPU selectively receives facility-related information, manufacturing process information, component specification information and process order information from the manufacturing data server DBn pursuant to the designer's selection and control through an application program and stores them in the database DB.

As described above, the facility-related information includes processing time information for each process for the manufacturing lines ML(n). In addition, the component specification information includes information containing component specifications and standards for manufactured and assembled products. The manufacturing process information contains manufacturing process order information, input order information, and input location information for each component and material for manufactured and assembled products.

The designer sequentially selects and inputs the facility-related information and the component standard information along with product information, such as part numbers, specifications, and standards for manufactured and assembled products, through a menu bar and an option window of the application program displayed on the screen of the display device 10. Then, the designer sequentially selects manufacturing process information and the like and sets the corresponding information. Accordingly, the interface processing unit IPU may sequentially read the facility-related information, the manufacturing process information, the component specification information, and the process order information from the manufacturing data server DBn pursuant to the designer's selection and setting information and may store them in the database DB.

The manufacturing process setting unit 111 receives the designers' requirements and the work environment information through the application program and sets step-by-step process information containing process details and order according to the designers' requirements, process sections for the process details, logistics volume of components, and supply location information of components.

For example, according to the designer's selection and input operation through the application program, the manufacturing process setting unit 111 may receive work environment information, for example, the input and output locations of components for each process zone for the manufacturing lines ML(n), area, gap, and space layout information for each process zone, environmental information, such as ambient temperature and humidity for each process zone, manufacturing resource information, such as logistical quantity and layout information for each component, etc., and may store them.

The optimized drawing designing unit 113 creates a layout drawing for the multiple transport equipment and the manufacturing lines ML(n) according to the reference design information, the standard information on the display panels, and the manufacturing process information based on the designers' requirements and the work environment information. Then, the optimized drawing designing unit 113 applies the step-by-step process information and the manufacturing process information to the layout drawing for the multiple transport equipment and the manufacturing lines ML(n) to create a simulation model.

The optimized drawing designing unit 113 applies to the simulation model the clustering shape for each of the manufacturing lines ML(n), the movement path of each product and component, the number of transfer equipment for each product and component, the movement path of the transfer equipment, and the process period of each process area for each of the manufacturing lines ML(n) as variables, varies the variables, and performs the simulation.

As described above, when performing the simulation, the optimized drawing designing unit 113 performs an optimization simulation to achieve conditions, such as shortening the processing time, reducing the space for each process section, minimizing the number of transport equipment, and minimizing the moving distance. For example, the optimized drawing designing unit 113 may reflect the specifications of the actual transport equipment and track the moving distance to calculate the availability and may optimize the number of transport equipment based on the calculation results to perform a simulation to design an efficient layout drawing.

The optimized drawing designing unit 113 stores the layout drawing and the final design drawing based on the optimization simulation results as the final results and transmits image data for the final layout drawing, the design drawing, etc., to the display device 10.

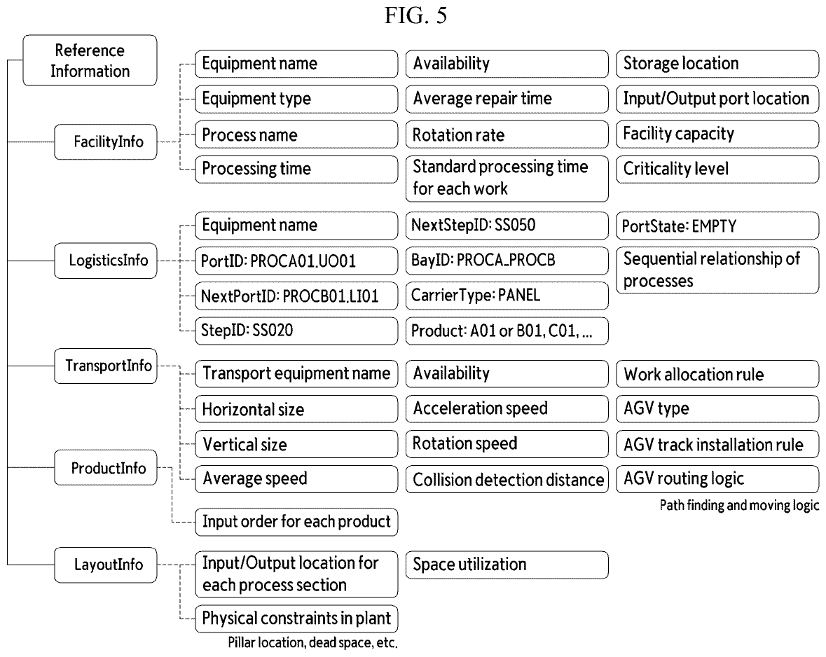

FIG. 5 schematically illustrates product information and design information input through a design information input unit shown in FIG. 4.

Referring to FIG. 5, the interface processing unit IPU may receive and store the facility-related information, such as facility name, facility type, process name, processing time, facility capacity, criticality level information for each facility, input and output locations for each product and component, and storage locations for each product and component from the manufacturing data server DBn pursuant to the designer's selection and control.

In addition, the interface processing unit IPU may receive and store the step-by-step logic design information, such as unique code numbers and IDs for each product and component, port IDs, space information for each standby location, and sequential relationship information for each process from the manufacturing data server DBn pursuant to the designer's selection and control.

In addition, the interface processing unit IPU may further receive and store, from the manufacturing data server DBn, specification information containing types of transport equipment, availability, work allocation rule information, standard information of transport equipment, transport speeds of transport equipment, etc., port information of transport units containing placement locations of transport equipment, path setting information of transport equipment, track installation information, etc., pursuant to the designer's selection and control.

In addition, the interface processing unit IPU may receive and store the manufacturing process information containing input/output locations for each process section, space information, and input order for each product and component, from the manufacturing data server DBn pursuant to the designer's selection and control.

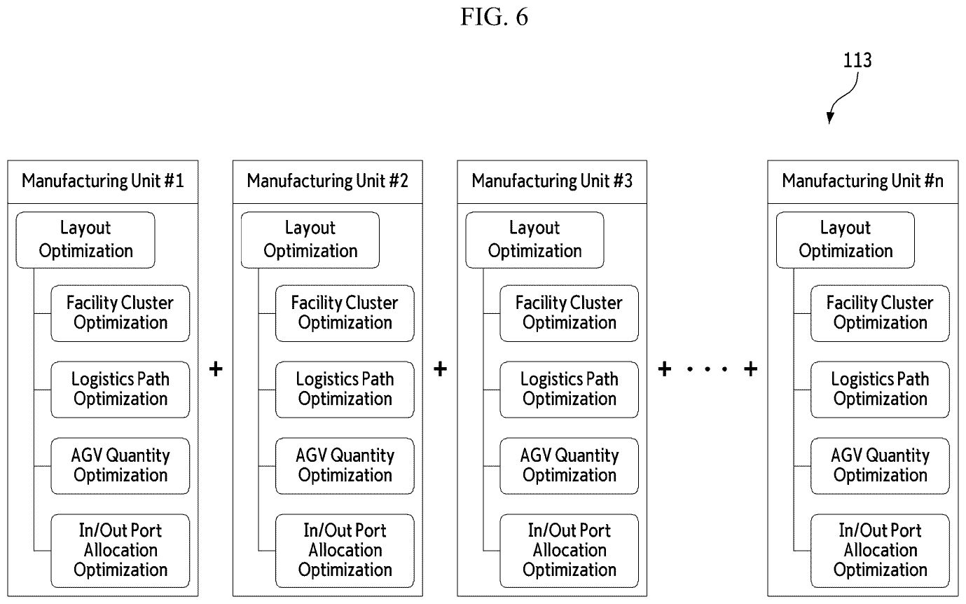

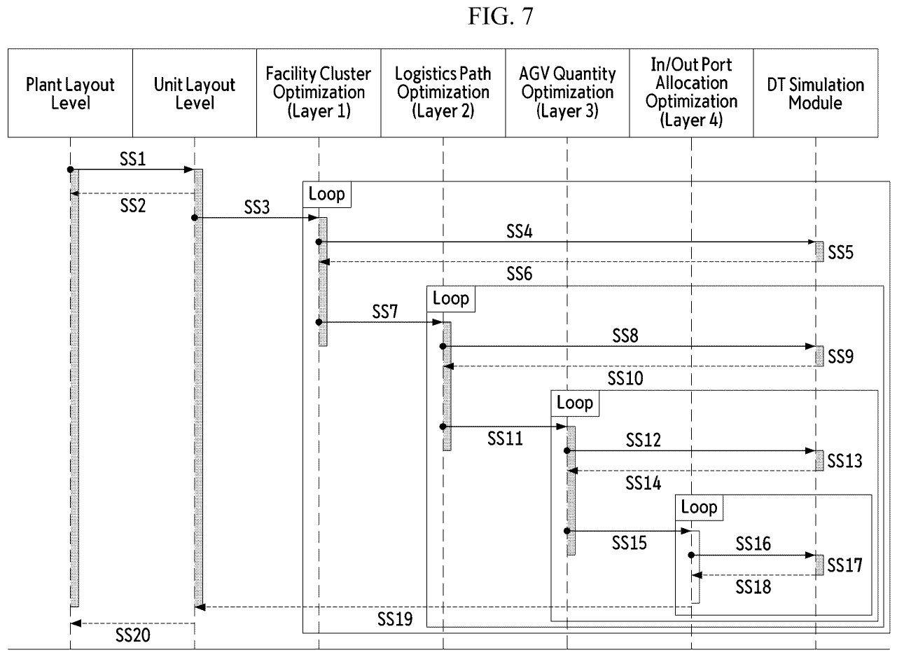

FIG. 6 schematically shows information on the space and facility design layout of the manufacturing lines shown in FIG. 4. FIG. 7 is a flowchart sequentially describing a process of deriving the plant layout and design results by an optimization design control processing unit shown in FIG. 4 and a process of verifying it.

Referring to FIGS. 6 and 7, the optimized drawing designing unit 113 applies to the reference design information the designers' requirements and types of facilities, process names, processing times, capacity of facilities, criticality level information for each facility, input and output locations for each product and component, and storage locations for each product and component input through the interface processing unit IPU, to create a first layout drawing for the manufacturing lines ML(n) (step SS1).

In addition, the optimized drawing designing unit 113 applies the input and output locations of components for each process section, area, distance, and space layout information for each process section, environmental information, such as ambient temperature and humidity for each process section, manufacturing resource information such as logistical quantity and placement information of each component, etc., to the first layout drawing to modify the first layout drawing, and creates a second layout drawing based on modulation results (step SS2).

Subsequently, the optimized drawing designing unit 113 applies the process details and order, process section for each process detail, logistics quantity of parts, and supply location information of parts entered through the interface processing unit IPU to the second layout drawing to modify the second layout drawing and creates a simulation model based on modulation results (step SS3).

Subsequently, the optimized drawing designing unit 113 applies information containing specifications and standards for each part of the manufactured and assembled products input through the interface processing unit IPU to the simulation model and performs a first simulation operation (step SS4). Then, the optimized drawing designing unit 113, along with product information, such as part numbers, specifications, and standards for manufactured and assembled products, sequentially applies the facility-related information and the component specification information to the simulation model to supplement the first simulation model (step SS5).

Subsequently, the optimized drawing designing unit 113 applies the manufacturing process order information, input order information, and input location information for each component and material for manufactured and assembled products to the simulation model, thereby secondly supplementing the first simulation model (step SS6).

Subsequently, the optimized drawing designing unit 113 applies step-by-step logic design information, such as unique code numbers and IDs for each product and component, port IDs, space information for each standby location, and sequential relationship information for each process, thereby thirdly supplementing the first simulation model (step SS7).

In addition, the optimized drawing designing unit 113 applies to the thirdly supplemented simulation model the clustering shape for each of the manufacturing lines ML(n), the movement path of each product and component, the number of transfer equipment for each product and component, the movement path of the transfer equipment, and the process period of each process area for each of the manufacturing lines ML(n) as variables, varies the variables, and sequentially performs the second simulation (step SS8).

The optimized drawing designing unit 113 additionally enters to the simulation model the specification information containing types of transport equipment, availability, work allocation rule information, standard information of transport equipment, transport speed of transport equipment, etc., and the port information of transport units containing the placement locations of transport equipment, path setting information of transport equipment, track installation information, etc. (step SS9). Then, the optimized drawing designing unit 113 applies to the simulation model the specification information containing the types of transport equipment, the availability, the work allocation rule information, the standard information of transport equipment, the transport speed of transport equipment, etc., and the placement locations of transport equipment, the path setting information of transport equipment and the track installation information as variables, to further perform a third simulation by varying the variables (step SS10).

The optimized drawing designing unit 113 applies to the simulation model the spatial information for each process section and input order for each product and each component, thereby finally resetting the output locations of the products (step SS11).

The optimized drawing designing unit 113 applies, to the simulation model after the output locations have been reset, the specification information containing the types of transport equipment, the availability, the work allocation rule information, the standard information of transport equipment, the transport speed of transport equipment, etc., and the placement locations of transport equipment, the path setting information of transport equipment and the track installation information by varying them as the second, the third, the fourth, . . . , the n^{th} variables, to further perform the simulations n times according to the variables varied n times (step SS16).

The optimized drawing designing unit 113 stores the layout drawing and the final design drawing based on the optimization simulation results as the final results and transmits image data for the final layout drawing and design drawing to the display device 10 (steps SS17 and SS18).

The optimized drawing designing unit 113 again stores in the interface processing unit IPU and the manufacturing data server DBn the specification information containing the types of transport equipment, the availability, the work allocation rule information, the standard information of transport equipment, the transport speed of transport equipment, etc., and the placement locations of transport equipment, the path setting information of transport equipment and the track installation information which are varied as the second, the third, the fourth, . . . , the n^{th} variables (steps SS19 and SS20).

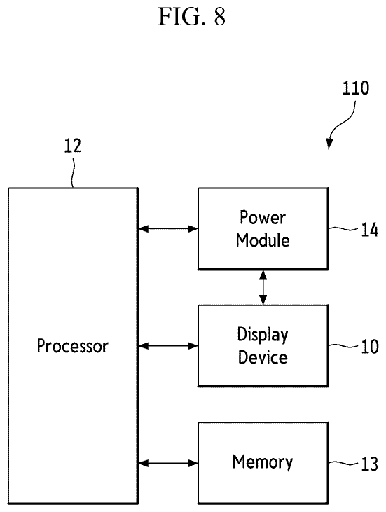

FIG. 8 is a block diagram describing an electronic device including a display device according to an embodiment of the present disclosure.

Referring to FIG. 8, an electronic device 110 according to an embodiment of the present disclosure may include a display device 10, a main processor 12, a memory 13, and a power module 14.

The main processor 12 may include at least one of: a central processing unit (CPU), an application processor (AP), a graphic processing unit (GPU), a communication processor (CP), an image signal processor (ISP), and a controller.

The main processor 12 may be applied and utilized as a layout design processing unit including the interface processing unit IPU, the manufacturing process setting unit 111, and the optimized drawing designing unit 113 as shown in, for example, FIG. 4. The layout design processing unit of the main processor 12 has been described above with reference to FIGS. 4 to 7 and will not be repeated again.

The memory 13 may store data information required for the operation of the main processor 12 or the display device 10. When the main processor 12 executes an application stored in the memory 13, an image data signal and/or an input control signal may be transmitted to the display device 10. The display device 10 may process the received signal and output image information through a display screen.

The power module 14 may include a power supply module, such as a power adapter and a battery device, and a power conversion module that converts the power supplied by the power supply module to generate power required for the operation of the electronic device 110.

At least one of the elements of the electronic device 110 described above may be included in the display devices according to the embodiments described above. In addition, some of the individual modules functioning as a single module may be included in the display device 10 while some others may be provided separately from the display device 10. For example, the display device 10 may include a display module, and the main processor 12, the memory 13 and the power module 14 may be provided as other devices inside the electronic device 110 than the display device 10.

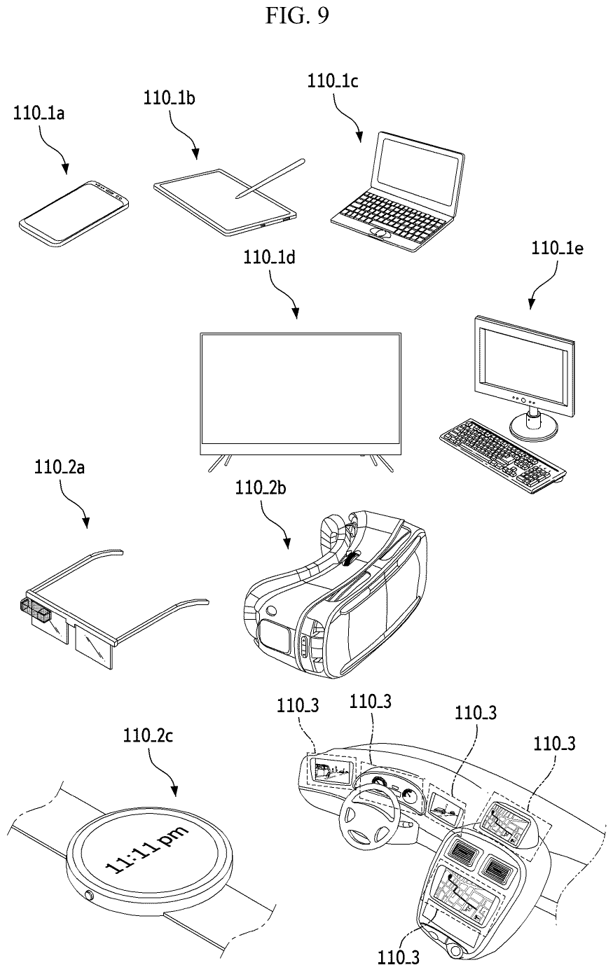

FIG. 9 is a view showing electronic devices according to a variety of embodiments of the present disclosure.

Referring to FIG. 9, a variety of electronic devices 110 employing the display devices 10 according to embodiments may include not only image display electronic devices, such as a smart phone 110_1a, a tablet PC 110_1b, a laptop computer 110_1c, a TV 110_1d, and a desktop monitor 110_1e, but also wearable electronic devices including display modules, such as smart glasses 110_2a, a head-mounted display 110_2b, and a smart watch 110_2c, and electronic devices for vehicles 110_3 including display modules, such as a center information display (CID) placed on the dashboard, the center fascia and the dashboard of a vehicle, and a room mirror display. Additionally, the display device 10 may be used as a display member of a television, a laptop computer, a monitor, an electronic billboard, or an Internet of Things (IoT) device.

In concluding the detailed description, those skilled in the art will appreciate that many variations and modifications can be made to the embodiments described herein without substantially departing from the principles of the present disclosure. Therefore, the embodiments of the present disclosure described herein are used in a generic and descriptive sense and not for purposes of limitation.

What is claimed is:

1. A system for designing manufacturing facilities for a display device, the system comprising:
a manufacturing data server configured to share reference design information for manufacturing lines, standard information for display devices to be manufactured and assembled, and manufacturing process information;
an electronic device configured to create a layout drawing and a final design drawing for a plurality of transport equipment and the manufacturing lines according to the reference design information, the standard information for the display devices, and the manufacturing process information based on design requirements and work environment information; and
a display device configured to receive the design requirements and the work environment information and to display a simulation process of the electronic device, the layout drawing, and the final design drawing as images.

2. The system of claim 1, wherein the electronic device comprises:
an interface processing unit configured to receive the reference design information for the manufacturing lines and stores it in a database, to sequentially receive and store, in a memory, standard information for each component of display panels or display devices of the be manufactured and the manufacturing process information;
a manufacturing process setting unit configured to receive the design requirements and the work environment information through an application program, and to set step-by-step process information containing process details and order according to the design requirements, processing sections for process details, logistics quantity of components, and supply location information of components; and
a hierarchical optimized drawing designing unit configured to apply the step-by-step process information and the manufacturing process information to the layout drawing for the transport equipment and the manufacturing lines to create a simulation model and to create the final design drawing according to simulation results.

3. The system of claim 2, wherein the optimized drawing designing unit is configured to:
apply a clustering shape set for each manufacturing line, moving paths for each product and component, numbers of the transport equipment for each product and component, moving paths for the transport equipment, and process periods of process sections for each manufacturing line to the simulation model as variables, and sequentially varies the variables to sequentially perform the simulation;
when performing the simulation, perform the simulation to achieve conditions of shortening a processing time, reducing space for each process section, and minimizing number and moving distance of the transport equipment; and
when performing the simulation, reflect specifications of the transport equipment and to track the moving distance to calculate the availability to design the layout drawing with minimized or optimized number of the transport equipment.

4. The system of claim 2, wherein the display device is configured to display a design and simulation application execution screen on a display panel, to receive the design requirements and the work environment information through an input device comprising a touch screen or a keyboard, and to provide them to the electronic device, and
wherein the display device is configured to display the simulation process of the electronic device, the layout drawing, and the final design drawing as images through the application execution screen.

5. The system of claim 2, wherein the optimized drawing designing unit is configured to apply to the reference design information the design requirements and types of facilities, process names, processing times, capacity of facilities, criticality level information for each facility, input and output locations for each product and component, and storage locations for each product and component input through the interface processing unit, and to create a first layout drawing for the manufacturing lines.

6. The system of claim 5, wherein the optimized drawing designing unit is configured to apply the input and output locations of components for each process section, area, distance, and space layout information for each process section, environmental information containing ambient temperature and humidity information for each process section, manufacturing resource information containing logistical quantity and placement information of each component input through the manufacturing process setting unit, to the first layout drawing to modify the first layout drawing, and to create a second layout drawing based on modulation results.

7. The system of claim 6, wherein the optimized drawing designing unit is configured to apply the process details and order, the process section for each process detail, the logistics quantity of components, and supply location information of components input through the interface processing unit to the second layout drawing to modify the second layout drawing, and to create a simulation model based on modulation results.

8. The system of claim 7, wherein the optimized drawing designing unit is configured to:
apply information containing specifications and standards for each component of the manufactured and assembled products input through the interface processing unit to the simulation model to perform a first simulation operation;
selectively apply facility-related information and standard information for each component to the simulation model sequentially along with product information according to the part number, specifications and standards for the manufactured and assembled products to supplement the first simulation model;
apply the manufacturing process information, the input order information and input location information of each component and material for the manufactured and assembled products to the first supplemented simulation model to secondly supplement the first simulation model; and
apply step-by-step logic design information containing unique code numbers and IDs for each product and component, port IDs, space information for each standby location, and sequential relationship information for each process to thirdly supplement the second simulation model.

9. The system of claim 8, wherein the optimized drawing designing unit is configured to apply a clustering shape set for each manufacturing line, moving paths for each product and component, numbers of the transport equipment for each product and component, moving paths for the transport equipment, and process periods of process sections for each manufacturing line to the thirdly supplemented simulation model as variables, and to vary the variables to sequentially perform second simulation.

10. The system of claim 9, wherein the optimized drawing designing unit is configured to:
enter in the secondly simulated simulation model specification information containing types of transport equipment, availability, work allocation rule information, standard information of transport equipment and transport speed of transport equipment, and placement locations of transport equipment, path setting information of transport equipment, track installation information and port information of transport units; and
apply the specification information containing types of transport equipment, availability, work allocation rule information, standard information of transport equipment and transport speed of transport equipment, and the placement locations of transport equipment, the path setting information of transport equipment, the track installation information and the port information of transport units as variables and varies the variables to perform third simulation.

11. The system of claim 10, wherein the optimized drawing designing unit is configured to:
apply spatial information for each process section and input order for each product and component to the thirdly simulated simulation model to reset output locations of the products;
apply the specification information containing types of transport equipment, availability, work allocation rule information, standard information of transport equipment and transport speed of transport equipment, and the placement locations of transport equipment, the path setting information of transport equipment and the track installation information as second, third fourth, . . . , n^{th} variables, and further perform simulation n times according to the variables varies n times; and
store the layout drawing and the final design drawing according to the n^{th} simulated results as final results, transmit image data for the final layout drawing and design drawing to the display device.

12. An electronic device for creating a layout drawing and a final design drawing for a plurality of transport equipment and manufacturing lines,
wherein the electronic device is configured to:
receive reference design information for the manufacturing lines, standard information for display devices to be manufactured and assembled, and manufacturing process information from a manufacturing data server;
receive design requirements and work environment information through a display device, to control the layout drawing and the final design drawing according to simulation results to be displayed on the display device; and
create the layout drawing and the final design drawing for the transport equipment and the manufacturing lines according to the reference design information, the standard information for the display devices and the manufacturing process information based on the designer's requirements and the work environment information.

13. The electronic device of claim 12, wherein the electronic device comprises:
an interface processing unit configured to receive the reference design information for the manufacturing lines and to store it in a database and to sequentially receive and store, in a memory, standard information for each component of display panels or display devices to be manufactured and the manufacturing process information;
a manufacturing process setting unit configured to receive the design requirements and the work environment information through an application program, and to set step-by-step process information containing process details and order according to the designer's requirements, processing sections for process details, logistics quantity of components, and supply location information of components; and
a hierarchical optimized drawing designing unit configured to apply the step-by-step process information and the manufacturing process information to the layout drawing for the transport equipment and the manufacturing lines to create a simulation model, and to create the final design drawing according to simulation results.

14. The electronic device of claim 13, wherein the optimized drawing designing unit is configured to apply to the reference design information the design requirements and types of facilities, process names, processing times, capacity of facilities, criticality level information for each facility, input and output locations for each product and component, and storage locations for each product and component input through the interface processing unit, to create a first layout drawing for the manufacturing lines, and
wherein the optimized drawing designing unit is configured to apply the input and output locations of components for each process section, area, distance, and space layout information for each process section, environmental information containing ambient temperature and humidity information for each process section, manufacturing resource information containing logistical quantity and placement information of each component input through the manufacturing process setting unit to the first layout drawing to modify the first layout drawing, and to create a second layout drawing based on modulation results.

15. The electronic device of claim 14, wherein the optimized drawing designing unit is configured to apply the process details and order, the process section for each process detail, the logistics quantity of components, and supply location information of components input through the interface processing unit to the second layout drawing to modify the second layout drawing, and to create a simulation model based on modulation results,
wherein the optimized drawing designing unit is configured to apply information containing specifications and standards for each component of the manufactured and assembled products input through the interface processing unit to the simulation model to perform a first simulation operation,
wherein the optimized drawing designing unit is configured to selectively apply facility-related information and standard information for each component to the simulation model sequentially along with product information according to the part number, specifications, and standards for the manufactured and assembled products to supplement the first simulation model,
wherein the optimized drawing designing unit is configured to apply the manufacturing process information, the input order information and input location information of each component and material for the manufactured and assembled products to the first supplemented simulation model to secondly supplement the first simulation model, and
wherein the optimized drawing designing unit configured to apply step-by-step logic design information containing unique code numbers and IDs for each product and component, port IDs, space information for each standby location, and sequential relationship information for each process to thirdly supplement the second simulation model.

16. The electronic device of claim 15, wherein the optimized drawing designing unit configured to apply a clustering shape set for each manufacturing line, moving paths for each product and component, numbers of the transport equipment for each product and component, moving paths for the transport equipment, and process periods of process sections for each manufacturing line to the thirdly supplemented simulation model as variables, and to vary the variables to sequentially perform second simulation.

17. The electronic device of claim 16, wherein the optimized drawing designing unit is configured to:
enter in the secondly simulated simulation model specification information containing types of transport equipment, availability, work allocation rule information, standard information of transport equipment and transport speed of transport equipment, and placement locations of transport equipment, path setting information of transport equipment, track installation information and port information of transport units; and
apply the specification information containing types of transport equipment, availability, work allocation rule information, standard information of transport equipment and transport speed of transport equipment, and the placement locations of transport equipment, the path setting information of transport equipment, the track installation information and the port information of transport units as variables and varies the variables to perform third simulation.

18. The electronic device of claim 17, wherein the optimized drawing designing unit configured to:
apply spatial information for each process section and input order for each product and component to the thirdly simulated simulation model to reset output locations of the products;
apply the specification information containing types of transport equipment, availability, work allocation rule information, standard information of transport equipment and transport speed of transport equipment, and the placement locations of transport equipment, the path setting information of transport equipment and the track installation information as second, third fourth, ..., n^{th} variables, to further perform simulation n times according to the variables varies n times; and
store the layout drawing and the final design drawing according to the n^{th} simulated results as final results, and transmit image data for the final layout drawing and design drawing to the display device.

19. A display device comprising:
a display panel configured to display a design and simulation application processing execution image on a screen; and
a display driver circuit configured to control an image display operation of the display panel,
wherein the display driver circuit is configured to receive design requirements and work environment information through an input device comprising a touch screen or a keyboard and to provide them to an electronic device, and
wherein the display driver circuit is configured to control the image display operation of the display panel so that a simulation process of the electronic device and a layout drawing and a final design drawing are displayed as images on the application execution screen.

20. The display device of claim 19, wherein the electronic device is configured to:
receive reference design information for the manufacturing lines, standard information for display devices to be manufactured and assembled, and manufacturing process information from a manufacturing data server;
receive design requirements and work environment information through a display device and control the layout drawing and the final design drawing according to simulation results to be displayed on the display device; and
create the layout drawing and the final design drawing for the transport equipment and the manufacturing lines according to the reference design information, the standard information of the display devices and the manufacturing process information based on the design requirements and the work environment information.
